(19) United States
(12) Patent Application Publication
(10) Pub. No.: US 2024/0397056 A1
(43) Pub. Date: Nov. 28, 2024

(54) LOW COMPLEXITY ENHANCEMENT VIDEO CODING WITH TEMPORAL SCALABILITY

(71) Applicant: V-NOVA INTERNATIONAL LIMITED, London (GB)

(72) Inventors: Florian MAURER, London (GB); Lorenzo CICCARELLI, London (GB); Simone FERRARA, London (GB)

(21) Appl. No.: 18/693,871

(22) PCT Filed: Sep. 21, 2022
(86) PCT No.: PCT/GB2022/052379

§ 371 Date: Mar. 20, 2024

(30) Foreign Application Priority Data
Sep. 21, 2021 (GB) 2113459.8

(51) Int. Cl. H04N 19/154; H04N 19/159; H04N 19/30; H04N 19/59

(52) U.S. Cl. CPC H04N 19/154; H04N 19/159; H04N 19/30; H04N 19/59

(57) ABSTRACT

The present disclosure relates to methods of encoding and decoding a video signal having temporal scalability. An encoder and decoder are also disclosed. The method of encoding a video signal comprises obtaining a base encoding of an input video signal, the base encoding being encoded using a base encoder to encode the input video signal at a first frame rate; and encoding the input video signal using an enhancement encoder to generate an enhancement encoding of the input video signal at a second frame rate, the enhancement encoder encoding the input video signal using at least a set of frames derived from the base encoding.

### TECHNICAL FIELD

The present disclosure generally relates to scalable video coding schemes, in particular encoding and decoding schemes (e.g., codecs) having temporal scalability.

### BACKGROUND

An encoded video signal having temporal scalability can be decoded (by a decoder) at different levels of temporal quality (e.g., at different frame rates). This is advantageous because it means that a single encoded video signal can be sent to many types of decoding devices (each having different operating capabilities), and each device can decode the encoded video signal in line with the operating capability of the decoder. For example, a first decoding device (such as a smart phone) may only be able to decode and render encoded video signal at 30 frames per second (fps) whereas a second decoding device (e.g., a laptop) may be able to decode and render encoded video signal at 60 fps. If an encoded video signal does not have temporal scalability, then a first encoded video signal at 30 fps would need to be sent to the first decoding device and a second encoded video signal at 60 fps would be sent to the second decoding device. Therefore, it is desirable to have an (single) encoded video signal that can be decoded at 30 fps by the first decoding device and 60 fps by the second decoding device.

Although certain video coding schemes have offered the prospect of temporal scalability, in the past implementations have generally struggled to gain widespread use. This is due to several reasons. Firstly, devices that are able to offer faster framerates have traditionally been rare, especially within mobile devices where higher frame rates result in greater battery consumption. Secondly, devices such as televisions typically received broadcast television with frame rates constrained by over-the-air transmission schemes, with online video using different encoding and transport mechanisms. Thirdly, available screen refresh rates have limited higher frame rate adoption.

However, the rising adoption of virtual and augmented reality technology and high specification mobile devices means that the demand for temporal scalability is increasing. Higher frame rates are often difficult to consciously detect (e.g., above 30 fps) but result in qualitative improvements in the smoothness of motion and responsiveness. This is especially the case with sports, action scenes, and interactive content. Also, many users report that virtual reality environments and 3D immersive videos running at 120 fps induce less motion sickness and improve realism. New virtual and augmented reality headsets are thus being added to the set of heterogeneous video receiving devices that include low-power mobile devices, projectors, televisions, and computers.

Even if all decoding devices have the same decoding capabilities, there are still advantages to having an encoded video signal with temporal scalability. This is because a decoder can better adapt to bandwidth available to the decoder. For example, if the decoder has access to a relatively high bandwidth signal, then the decoder can decode at a high temporal quality (i.e. 60 fps); if the decoder only has access to a relatively low bandwidth signal then the decoder can decode at a low temporal quality (i.e. 30 fps).

There is thus a need for encoded video signals having temporal scalability.

### SUMMARY

Aspects and variations of the present invention are set out in the appended claims. Certain unclaimed aspects are further set out in the detailed description below.

### BRIEF DESCRIPTION OF THE FIGURES

FIG. 1 is a block diagram showing an example signal encoding system.

FIG. 2 is a block diagram showing an example signal decoding system.

FIG. 3 is a schematic diagram showing generation of an example video bitstream.

FIG. 4 is a schematic diagram showing different portions of data that may be generated as part of an example video encoding.

FIG. 5 illustrates an example of a comparative video coding system with two streams, where neither stream has temporal scalability.

FIG. 6 illustrates an example of a comparative video coding system with a single stream having temporal scalability.

FIG. 7 illustrates an example of a comparative video coding system having a base layer and an interlaced enhancement layer to implement temporal scalability.

FIG. 8 illustrates an example of a video coding scheme according to the present disclosure that has a temporally scalable base stream and a temporally scalable enhancement stream.

FIG. 9 is a flow chart showing a method of providing temporal scalability according to an example of the present disclosure.

FIG. 10 is a flow chart showing a method of providing temporal scalability according to another example of the present disclosure.

FIG. 11 is a flow chart showing a method of providing temporal scalability according to a further example of the present disclosure.

FIG. 12 is a schematic diagram showing an encoding system according to an example of the present disclosure.

FIG. 12 is a schematic diagram showing an encoding system according to an example of the present disclosure.

FIG. 13 is a schematic diagram showing an encoding system according to another example of the present disclosure.

FIG. 14 is a schematic diagram showing a decoding system according to an example of the present disclosure.

FIG. 15 is a schematic diagram showing a decoding system according to another example of the present disclosure.

FIG. 16 illustrates a number of frames having a frame structure that provides for dropping 50% and 25% of the frames.

FIG. 17 illustrates a number of frames having a frame structure that provides for dropping 50% and 87.5% of the frames.

FIG. 18 illustrates a number of frames having a frame structure that provides for dropping two thirds (and eight ninths) of the frames.

### DETAILED DESCRIPTION

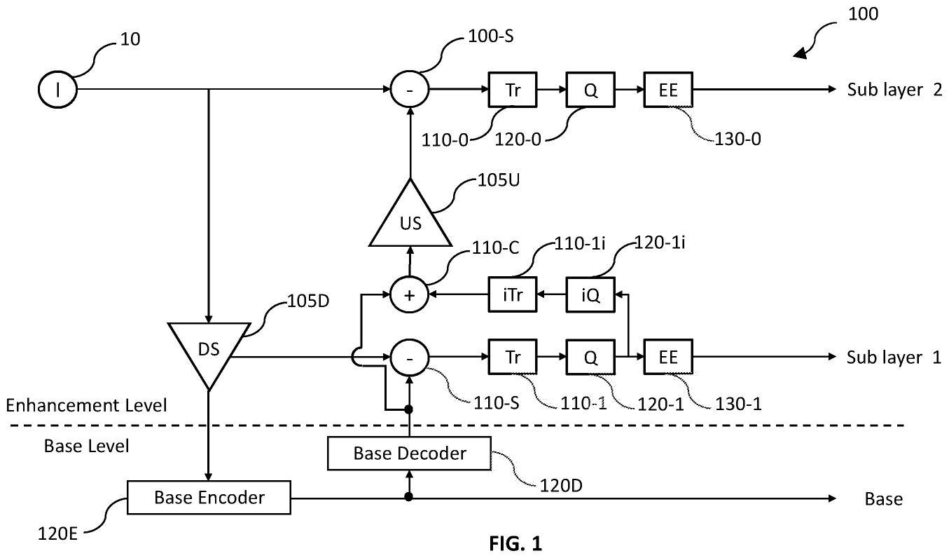

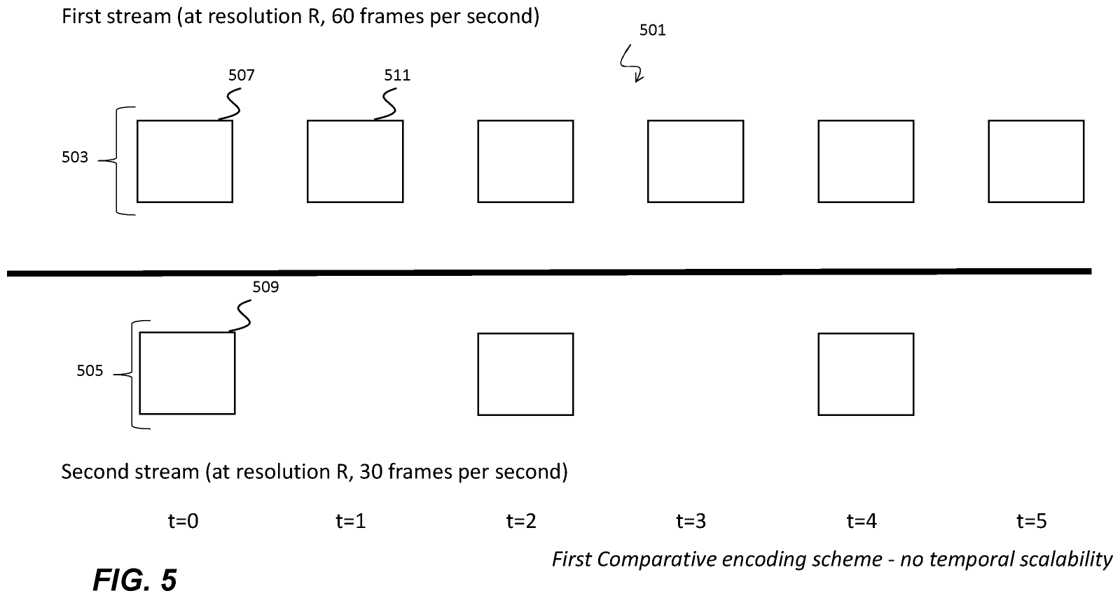

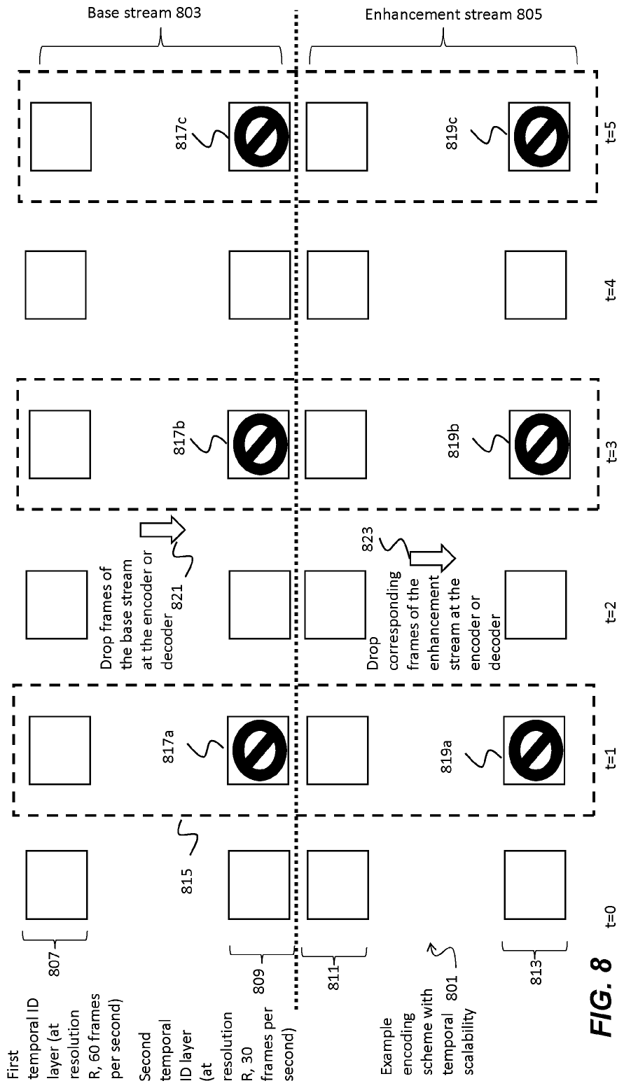

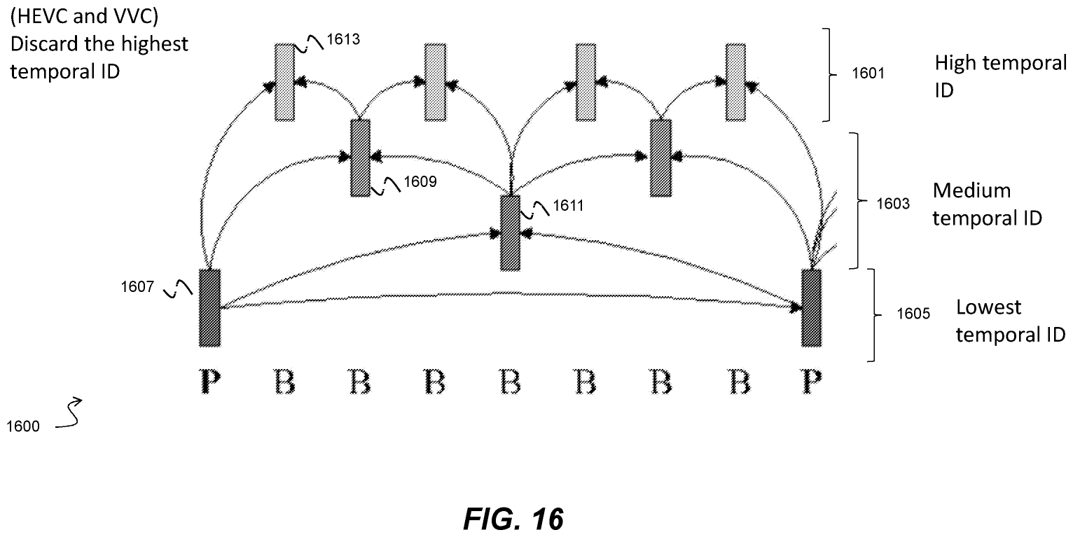

In the detailed description below, spatial and/or quality scalability aspects of an example signal coding scheme are first described with reference to FIGS. 1 to 4. Comparative signal coding schemes with temporal scalability are then described with reference to FIGS. 5 to 7. These comparative signal coding schemes are described to provide context for a new temporal scalability scheme. Various examples of this new temporal scalability scheme are then described with reference to FIGS. 8 to 15. FIGS. 16 to 18 then show three reference frame structures that may be used with temporal scalability. The examples of the temporal scalability scheme of FIGS. 8 to 15 may be combined with one or more of the spatial and/or quality scalability aspects applied by the example signal coding scheme of FIGS. 1 to 4.

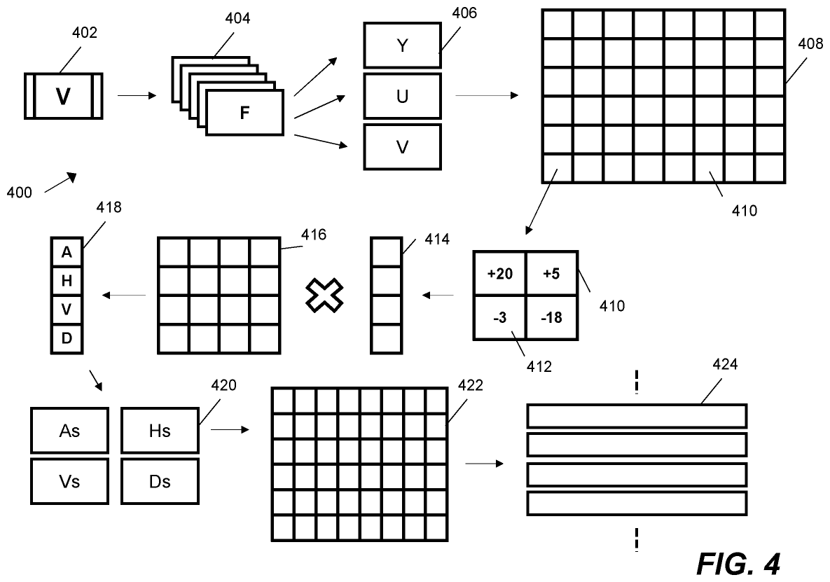

Examples are presented herein with reference to a signal as a sequence of samples (i.e., two-dimensional images, video frames, video fields, sound frames, etc.). For simplicity, non-limiting embodiments illustrated herein often refer to signals that are displayed as 2D planes of settings (e.g., 2D images in a suitable colour space), such as for instance a video signal. In a preferred case, the signal comprises a video signal. An example video signal is described in more detail with reference to FIG. 4.

The terms “picture”, “frame” or “field” will be used interchangeably with the term “image”, so as to indicate a sample in time of the video signal: any concepts and methods illustrated for video signals made of frames (progressive video signals) can be easily applicable also to video signals made of fields (interlaced video signals), and vice versa. Despite the focus of embodiments illustrated herein on image and video signals, people skilled in the art can easily understand that the same concepts and methods are also applicable to any other types of multidimensional signal (e.g., audio signals, volumetric signals, stereoscopic video signals, 3DoF/6DoF video signals, plenoptic signals, point clouds, etc.). Although image or video coding examples are provided, the same approaches may be applied to signals with dimensions fewer than two (e.g., audio or sensor streams) or greater than two (e.g., volumetric signals).

In the description the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “element”, or “pel”, or display element for two-dimensional images often called “pixel”, for volumetric images often called “voxel”, etc.) characterized by one or more “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal). In one case, a frame of a video signal may be seen to comprise a two-dimensional array with three colour component channels or a three-dimensional array with two spatial dimensions (e.g., of an indicated resolution—with lengths equal to the respective height and width of the frame) and one colour component dimension (e.g., having a length of 3). In certain cases, the processing described herein is performed individually to each plane of colour component values that make up the frame. For example, planes of pixel values representing each of Y, U, and V colour components may be processed in parallel using the methods described herein.

Certain examples described herein use a scalability framework that uses a base encoding and an enhancement encoding. The video coding systems described herein operate upon a received decoding of a base encoding (e.g., frame-by-frame or complete base encoding) and add one or more of spatial, temporal, or other quality enhancements via an enhancement layer. The base encoding may be generated by a base layer, which may use a coding scheme that differs from the enhancement layer, and in certain cases may comprise a legacy or comparative (e.g., older) coding standard.

### Example Scalable Coding Systems

FIGS. 1 to 4 show a spatially scalable coding scheme that uses a down-sampled source signal encoded with a base codec, adds a first level of correction or enhancement data to the decoded output of the base codec to generate a corrected picture, and then adds a further level of correction or enhancement data to an up-sampled version of the corrected picture. Thus, the spatially scalable coding scheme may generate an enhancement stream with two spatial resolutions (higher and lower), which may be combined with a base stream at the lower spatial resolution.

In the spatially scalable coding scheme, the methods and apparatuses may be based on an overall algorithm which is built over an existing encoding and/or decoding algorithm (e.g. MPEG standards such as AVC/H.264, HEVC/H.265, etc. as well as non-standard algorithms such as VP9, AV1, and others) which works as a baseline for an enhancement layer. The enhancement layer works accordingly to a different encoding and/or decoding algorithm. The idea behind the overall algorithm is to encode/decode hierarchically the video frame as opposed to using block-based approaches as done in the MPEG family of algorithms. Hierarchically encoding a frame includes generating residuals for the full frame, and then a reduced or decimated frame and so on.

FIG. 1 shows a system configuration for an example spatially scalable encoder 100. The encoding process is split into two halves as shown by the dashed line. Below the dashed line is a base level and above the dashed line is the enhancement level, which may usefully be implemented in software. The encoder 100 may comprise only the enhancement level processes, or a combination of the base level processes and enhancement level processes as needed. The encoder 100 topology at a general level is as follows. The encoder 100 comprises an input I for receiving an input signal 10. The input I is connected to a down-sampler 105D. The down-sampler 105D outputs to a base encoder 120E at the base level of the encoder 100. The down-sampler 105D also outputs to a residual generator 110-S. An encoded base stream is created directly by the base encoder 120E, and may be quantised and entropy encoded as necessary according to the base encoding scheme. The encoded base stream may be referred to as the base layer or base level.

To generate an encoded sub-layer 1 enhancement stream, the encoded base stream is decoded via a decoding operation that is applied at a base decoder 120D. In preferred examples, the base decoder 120D may be a decoding component that complements an encoding component in the form of the base encoder 120E within a base codec. In other examples, the base decoding block 120D may instead be part of the enhancement level. Via the residual generator 110-S, a difference between the decoded base stream output from the base decoder 120D and the down-sampled input video is created (i.e. a subtraction operation 110-S is applied to a frame of the down-sampled input video and a frame of the decoded base stream to generate a first set of residuals). Here, residuals represent the error or differences between a reference signal or frame and a desired signal or frame. The residuals used in the first enhancement level can be considered as a correction signal as they are able to ‘correct’ a frame of a future decoded base stream. This is useful as this can correct for quirks or other peculiarities of the base codec. These include, amongst others, motion compensation algorithms applied by the base codec, quantisation and entropy encoding applied by the base codec, and block adjustments applied by the base codec.

In FIG. 1, the first set of residuals are transformed, quantized and entropy encoded to produce the encoded sub-layer 1 stream. In FIG. 1, a transform operation 110-1 is applied to the first set of residuals; a quantization operation 120-1 is applied to the transformed set of residuals to generate a set of quantized residuals; and, an entropy encoding operation 130-1 is applied to the quantized set of residuals to generate the encoded sub-layer 1 stream at the first level of enhancement. However, it should be noted that in other examples only the quantisation step 120-1 may be performed, or only the transform step 110-1. Entropy encoding may not be used, or may optionally be used in addition to one or both of the transform step 110-1 and quantisation step 120-1. The entropy encoding operation can be any suitable type of entropy encoding, such as a Huffmann encoding operation or a run-length encoding (RLE) operation, or a combination of both a Huffmann encoding operation and a RLE operation (e.g., RLE then Huffmann or prefix encoding).

To generate the encoded sub-layer 2 stream, a further level of enhancement information is created by producing and encoding a further set of residuals via residual generator 100-S. The further set of residuals are the difference between an up-sampled version (via up-sampler 105U) of a corrected version of the decoded base stream (the reference signal or frame), and the input signal 10 (the desired signal or frame).

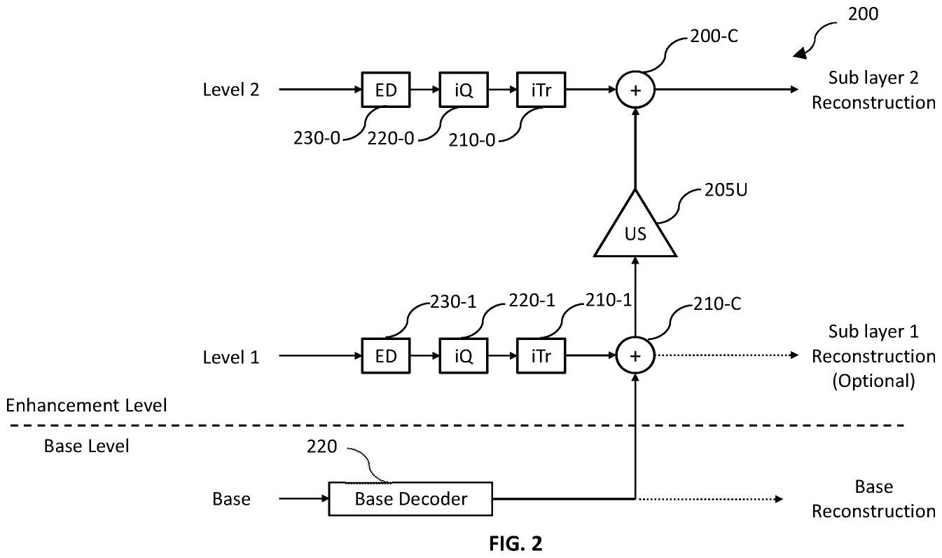

To achieve a reconstruction of the corrected version of the decoded base stream as would be generated at a decoder (e.g., as shown in FIG. 2), at least some of the sub-layer 1 encoding operations are reversed to mimic the processes of the decoder, and to account for at least some losses and quirks of the transform and quantisation processes. To this end, the first set of residuals are processed by a decoding pipeline comprising an inverse quantisation block 120-1i and an inverse transform block 110-1i. The quantized first set of residuals are inversely quantized at inverse quantisation block 120-1i and are inversely transformed at inverse transform block 110-1i in the encoder 100 to regenerate a decoder-side version of the first set of residuals. The decoded base stream from decoder 120D is then combined with the decoder-side version of the first set of residuals (i.e., a summing operation 110-C is performed on the decoded base stream and the decoder-side version of the first set of residuals). Summing operation 110-C generates a reconstruction of the down-sampled version of the input video as would be generated in all likelihood at the decoder—i.e. a reconstructed base codec video). The reconstructed base codec video is then up-sampled by up-sampler 105U. Processing in this example is typically performed on a frame-by-frame basis.

The up-sampled signal (i.e., reference signal or frame) is then compared to the input signal 10 (i.e., desired signal or frame) to create the further set of residuals (i.e., a difference operation is applied by the residual generator 100-S to the up-sampled re-created frame to generate a further set of residuals). The further set of residuals are then processed via an encoding pipeline that mirrors that used for the first set of residuals to become an encoded sub-layer 2 stream (i.e. an encoding operation is then applied to the further set of residuals to generate the encoded further enhancement stream). In particular, the further set of residuals are transformed (i.e. a transform operation 110-O is performed on the further set of residuals to generate a further transformed set of residuals). The transformed residuals are then quantized and entropy encoded in the manner described above in relation to the first set of residuals (i.e. a quantization operation 120-O is applied to the transformed set of residuals to generate a further set of quantized residuals; and, an entropy encoding operation 120-O is applied to the quantized further set of residuals to generate the encoded sub-layer 2 stream containing the further level of enhancement information). In certain cases, the operations may be controlled, e.g. such that, only the quantisation step 120-1 may be performed, or only the transform and quantization step. Entropy encoding may optionally be used in addition. Preferably, the entropy encoding operation may be a Huffmann encoding operation or a run-length encoding (RLE) operation, or both (e.g., RLE then Huffmann encoding). The transformation applied at both blocks 110-1 and 110-O may be a Hadamard transformation that is applied to 2×2 or 4×4 blocks of residuals.

The encoding operation in FIG. 1 does not result in dependencies between local blocks of the input signal (e.g., in comparison with many known coding schemes that apply inter or intra prediction to macroblocks and thus introduce macroblock dependencies). Hence, the operations shown in FIG. 1 may be performed in parallel on 4×4 or 2×2 blocks, which greatly increases encoding efficiency on multicore central processing units (CPUs) or graphical processing units (GPUs).

As illustrated in Figure, the output of the spatially scalable encoding process is one or more enhancement streams at an enhancement level which preferably comprises a first level of enhancement and a further level of enhancement. This is then combinable (e.g., via multiplexing or otherwise) with a base stream at a base level. The first level of enhancement (sub-layer 1) may be considered to enable a corrected video at a base level, that is, for example to correct for encoder quirks. The second level of enhancement (sub layer 2) may be considered to be a further level of enhancement that is usable to convert the corrected video to the original input video or a close approximation thereto. For example, the second level of enhancement may add fine detail that is lost during the downsampling and/or help correct from errors that are introduced by one or more of the transform operation 110-1 and the quantization operation 120-1.

FIG. 2 shows a corresponding example decoder 200 for the example spatially scalable coding scheme. The encoded base stream is decoded at base decoder 220 in order to produce a base reconstruction of the input signal 10. This base reconstruction may be used in practice to provide a viewable rendition of the signal 10 at the lower quality level. However, the primary purpose of this base reconstruction signal is to provide a base for a higher quality rendition of the input signal 10. To this end, the decoded base stream is provided for sub-layer 1 processing (i.e., sub-layer 1 decoding). Sub-layer 1 processing in FIG. 2 comprises an entropy decoding process 230-1, an inverse quantization process 220-1, and an inverse transform process 210-1. Optionally, only one or more of these steps may be performed depending on the operations carried out at corresponding block 100-1 at the encoder. By performing these corresponding steps, a decoded sub-layer 1 stream comprising the first set of residuals is made available at the decoder 200. The first set of residuals is combined with the decoded base stream from base decoder 220 (i.e., a summing operation 210-C is performed on a frame of the decoded base stream and a frame of the decoded first set of residuals to generate a reconstruction of the down-sampled version of the input video—i.e. the reconstructed base codec video). A frame of the reconstructed base codec video is then up-sampled by up-sampler 205U.

Additionally, and optionally in parallel, the encoded sub-layer 2 stream is processed to produce a decoded further set of residuals. Similar to sub-layer 1 processing, sub-layer 2 processing comprises an entropy decoding process 230-0, an inverse quantization process 220-0 and an inverse transform process 210-0. Of course, these operations will correspond to those performed at block 100-0 in encoder 100, and one or more of these steps may be omitted as necessary. Block 200-0 produces a decoded sub-layer 2 stream comprising the further set of residuals and these are summed at operation 200-C with the output from the up-sampler 205U in order to create a sub-layer 2 reconstruction of the input signal 10, which may be provided as the output of the decoder. Thus, as illustrated in FIGS. 1 and 2, the output of the decoding process may comprise up to three outputs: a base reconstruction, a corrected lower resolution signal and an original signal reconstruction at a higher resolution.

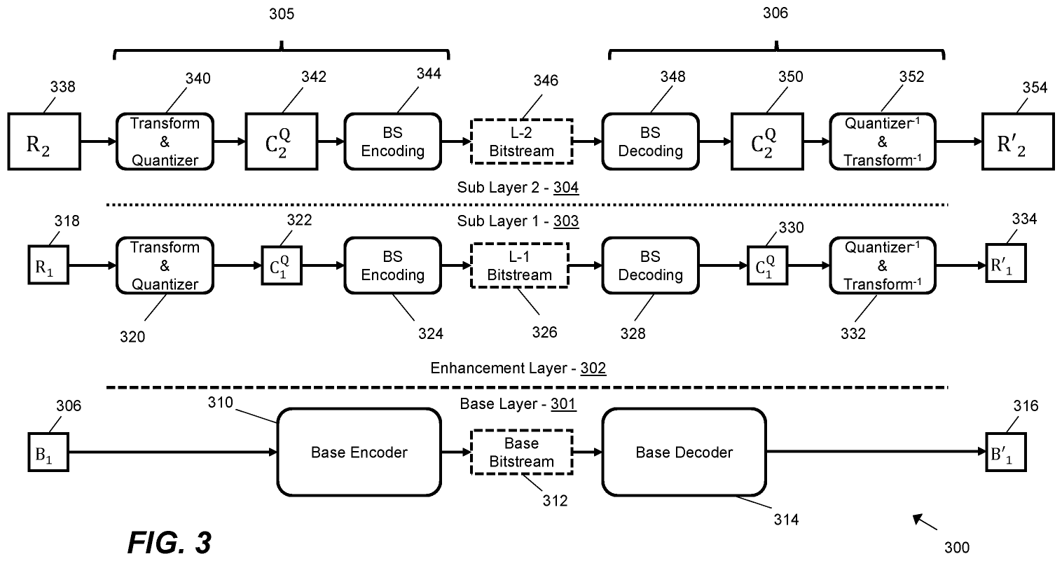

FIG. 3 shows an alternative representation of a scalable encoding scheme in the form of example signal coding system 300. The signal coding system 300 is a multi-layer or tier-based coding system, in that a signal is encoded via a plurality of bitstreams that each represent different encodings of the signal at different levels of quality (e.g., different spatial resolutions). In the example of FIG. 3, there is a base layer 301 and an enhancement layer 302. The enhancement layer 302 (and the enhancement layer of FIGS. 1 and 2) may implement an enhancement coding scheme such as LCEVC. LCEVC is described in PCT/GB2020/050695, and the associated standard specification documents including the Draft Text of ISO/IEC DIS 23094-2 Low Complexity Enhancement Video Coding published at MPEG 129 meeting in Brussels, held Monday, 13 Jan. 2020 to Friday, 17 Jan. 2020. Both of these documents are incorporated herein by reference. As per the example of FIGS. 1 and 2, in FIG. 3, the enhancement layer 301 comprises two sub-layers: a first sub-layer 303 and a second sub-layer 304. Each layer and sub-layer may be associated with a specific level of quality. Level of quality as used herein may refer to one or more of: sampling rate, spatial resolution, and bit depth, amongst others. In LCEVC, the base layer 301 is at a base level of quality, the first sub-layer 303 is at a first level of quality and the second sub-layer 304 is at a second level of quality. The base level of quality and the first level of quality may comprise a common (i.e., shared or same) level of quality or different levels of quality. In a case where the levels of quality correspond to different spatial resolutions, such as in LCEVC, inputs for each level of quality may be obtained by downsampling and/or upsampling from another level of quality. For example, the first level of quality may be at a first spatial resolution and the second level of quality may be at a second, higher spatial resolution, where signals may be converted between the levels of quality by downsampling from the second level of quality to the first level of quality and by upsampling from the first level of quality to the second level of quality.

In FIG. 3, corresponding encoder 305 and decoder 306 portions of the signal coding system 300 are illustrated. It will be noted that the encoder 305 and the decoder 306 may be implemented as separate products and that these need not originate from the same manufacturer or be provided as a single combined unit. The encoder 305 and decoder 306 are typically implemented in different geographic locations, such that an encoded data stream is generated in order to communicate an input signal between said two locations. Each of the encoder 305 and the decoder 306 may be implemented as part of one or more codecs—hardware and/or software entities able to encode and decode signals. Reference to communication of signals as described herein also covers encoding and decoding of files, wherein the communication may be within time on a common machine (e.g., by generating an encoded file and accessing it at a later point in time) or via physical transportation on a medium between two devices.

In certain preferred implementations, the components of the base layer 301 may be supplied separately to the components of the enhancement layer 302; for example, the base layer 301 may be implemented by hardware-accelerated codecs whereas the enhancement layer 302 may comprise a software-implemented enhancement codec. The base layer 301 comprises a base encoder 310. The base encoder 310 receives a version of an input signal to be encoded 306, for example a signal following one or two rounds of downsampling and generates a base bitstream 312. The base bitstream 312 is communicated between the encoder 305 and decoder 306. At the decoder 306, a base decoder 314 decodes the base bitstream 312 to generate a reconstruction of the input signal at the base level of quality 316.

Both enhancement sub-layers 303 and 304 comprise a common set of encoding and decoding components. The first sub-layer 303 comprises a first sub-layer transformation and quantisation component 320 that outputs a set of first sub-layer transformed coefficients 322. The first sub-layer transformation and quantisation component 320 receives data 318 derived from the input signal at the first level of quality and applies a transform operation. This data may comprise the first set of residuals as described above. The first sub-layer transformation and quantisation component 320 may also apply a variable level of quantisation to an output of the transform operation (including being configured to apply no quantisation). Quality scalability may be applied by varying the quantisation that is applied in one or more of the enhancement sub-layers. The set of first sub-layer transformed coefficients 322 are encoded by a first sub-layer bitstream encoding component 324 to generate a first sub-layer bitstream 326. This first sub-layer bitstream 326 is communicated from the encoder 305 to the decoder 306. At the decoder 306, the first sub-layer bitstream 326 is received and decoded by a first sub-layer bitstream decoder 328 to obtain a decoded set of first sub-layer transformed coefficients 330. The decoded set of first sub-layer transformed coefficients 330 are passed to a first sub-layer inverse transformation and inverse quantisation component 332. The first sub-layer inverse transformation and inverse quantisation component 332 applies further decoding operations including applying at least an inverse transform operation to the decoded set of first sub-layer transformed coefficients 330. If quantisation has been applied by the encoder 305, the first sub-layer inverse transformation and inverse quantisation component 332 may apply an inverse quantisation operation prior to the inverse transformation. The further decoding is used to generate a reconstruction of the input signal. In one case, the output of the first sub-layer inverse transformation and inverse quantisation component 332 is the reconstructed first set of residuals 334 that may be combined with the reconstructed base stream 316 as described above.

In a similar manner, the second sub-layer 304 also comprises a second sub-layer transformation and quantisation component 340 that outputs a set of second sub-layer transformed coefficients 342. The second sub-layer transformation and quantisation component 340 receives data derived from the input signal at the second level of quality and applies a transform operation. This data may also comprise residual data 338 in certain embodiments, although this may be different residual data from that received by the first sub-layer 303, e.g. it may comprise the further set of residuals as described above. The transform operation may be the same transform operation that is applied at the first sub-layer 303. The second sub-layer transformation and quantisation component 340 may also apply a variable level of quantisation before the transform operation (including being configured to apply no quantisation). The set of second sub-layer transformed coefficients 342 are encoded by a second sub-layer bitstream encoding component 344 to generate a second sub-layer bitstream 346. This second sub-layer bitstream 346 is communicated from the encoder 305 to the decoder 306. In one case, at least the first and second sub-layer bitstreams 326 and 346 may be multiplexed into a single encoded data stream. In one case, all three bitstreams 312, 326 and 346 may be multiplexed into a single encoded data stream. The single encoded data stream may be received at the decoder 306 and de-multiplexed to obtain each individual bitstream.

At the decoder 306, the second sub-layer bitstream 346 is received and decoded by a second sub-layer bitstream decoder 348 to obtain a decoded set of second sub-layer transformed coefficients 350. As above, the decoding here relates to a bitstream decoding and may form part of a decoding pipeline (i.e. the decoded set of transformed coefficients 330 and 350 may represent a partially decoded set of values that are further decoded by further operations). The decoded set of second sub-layer transformed coefficients 350 are passed to a second sub-layer inverse transformation and inverse quantisation component 352. The second sub-layer inverse transformation and inverse quantisation component 352 applies further decoding operations including applying at least an inverse transform operation to the decoded set of second sub-layer transformed coefficients 350. If quantisation has been applied by the encoder 305 at the second sub-layer, the inverse second sub-layer transformation and inverse quantisation component 352 may apply an inverse quantisation operation prior to the inverse transformation. The further decoding is used to generate a reconstruction of the input signal. This may comprise outputting a reconstruction of the further set of residuals 354 for combination with an upsampled combination of the reconstruction of the first set of residuals 334 and the base stream 316 (e.g., as described above).

The bitstream encoding components 324 and 344 may implement a configurable combination of one or more of entropy encoding and run-length encoding. Likewise, the bitstream decoding components 328 and 348 may implement a configurable combination of one or more of entropy encoding and run-length decoding.

Further details and examples of a two sub-layer enhancement encoding and decoding system may be obtained from published LCEVC documentation.

In general, examples described herein operate within encoding and decoding pipelines that comprises at least a transform operation. The transform operation may comprise the DCT or a variation of the DCT, a Fast Fourier Transform (FFT), or a Hadamard transform as implemented by LCEVC. The transform operation may be applied on a block-by-block basis. For example, an input signal may be segmented into a number of different consecutive signal portions or blocks and the transform operation may comprise a matrix multiplication (i.e., linear transformation) that is applied to data from each of these blocks (e.g., as represented by a 1D vector). In this description and in the art, a transform operation may be said to result in a set of values for a predefined number of data elements, e.g. representing positions in a resultant vector following the transformation. These data elements are known as transformed coefficients (or sometimes simply “coefficients”).

As described herein, where the signal data comprises residual data, a reconstructed set of coefficient bits may comprise transformed residual data, and a decoding method may further comprise instructing a combination of residual data obtained from the further decoding of the reconstructed set of coefficient bits with a reconstruction of the input signal generated from a representation of the input signal at a lower level of quality to generate a reconstruction of the input signal at a first level of quality. The representation of the input signal at a lower level of quality may be a decoded base signal (e.g. from base decoder 314) and the decoded base signal may be optionally upscaled before being combined with residual data obtained from the further decoding of the reconstructed set of coefficient bits, the residual data being at a first level of quality (e.g., a first resolution). Decoding may further comprise receiving and decoding residual data associated with a second sub-layer 304, e.g. obtaining an output of the inverse transformation and inverse quantisation component 352, and combining it with data derived from the aforementioned reconstruction of the input signal at the first level of quality. This data may comprise data derived from an upscaled version of the reconstruction of the input signal at the first level of quality, i.e. an upscaling to the second level of quality.

Although examples have been described with reference to a tier-based hierarchical coding scheme in the form of LCEVC, the methods described herein may also be applied to other tier-based hierarchical coding scheme, such as VC-6: SMPTE VC-6 ST-2117 as described in PCT/GB2018/053552 and/or the associated published standard document, which are both incorporated by reference herein.

FIG. 4 shows how a video signal may be decomposed into different components and then encoded. In the example of FIG. 4, a video signal 402 is encoded. The video signal 402 comprises a plurality of frames or pictures 404, e.g. where the plurality of frames represent action over time. In this example, each frame 404 is made up of three colour components. The colour components may be in any known colour space. In FIG. 4, the three colour components are Y (luma), U (a first chroma opponent colour) and V (a second chroma opponent colour). Each colour component may be considered a plane 408 of values. The plane 408 may be decomposed into a set of n by n blocks of signal data 410. For example, in LCEVC, n may be 2 or 4; in other video coding technologies n may be 8 to 32.

In LCEVC and certain other coding technologies, a video signal fed into a base layer such as 301 is a downscaled version of the input video signal 302. In this case, the signal that is fed into both sub-layers comprises a residual signal comprising residual data. A plane of residual data may also be organised in sets of n by n blocks of signal data 410. The residual data may be generated by comparing data derived from the input signal being encoded, e.g. the video signal 402, and data derived from a reconstruction of the input signal, the reconstruction of the input signal being generated from a representation of the input signal at a lower level of quality. In the example of FIG. 3, the reconstruction of the input signal may comprise a decoding of the encoded base bitstream 312 that is available at the encoder 305. This decoding of the encoded base bitstream 312 may comprise a lower resolution video signal that is then compared with a video signal downsampled from the input video signal 402. The comparison may comprise subtracting the reconstruction from the downsampled version. The comparison may be performed on a frame-by-frame (and/or block-by-block) basis. The comparison may be performed at the first level of quality; if the base level of quality is below the first level of quality, a reconstruction from the base level of quality may be upscaled prior to the comparison. In a similar manner, the input signal to the second sub-layer, e.g. the input for the second sub-layer transformation and quantisation component 340, may comprise residual data that results from a comparison of the input video signal 402 at the second level of quality (which may comprise a full-quality original version of the video signal) with a reconstruction of the video signal at the second level of quality. As before, the comparison may be performed on a frame-by-frame (and/or block-by-block) basis and may comprise subtraction. The reconstruction of the video signal may comprise a reconstruction generated from the decoded decoding of the encoded base bitstream 312 and a decoded version of the first sub-layer residual data stream. The reconstruction may be generated at the first level of quality and may be upsampled to the second level of quality.

Hence, a plane of data 408 for the first sub-layer 303 may comprise residual data that is arranged in n by n signal blocks 410. One such 2 by 2 signal block is shown in more detail in FIG. 4 (n is selected as 2 for ease of explanation) where for a colour plane the block may have values 412 with a set bit length (e.g. 8 or 16-bit). Each n by n signal block may be represented as a flattened vector 414 of length n² representing the blocks of signal data. To perform the transform operation, the flattened vector 414 may be multiplied by a transform matrix 416 (i.e. the dot product taken). This then generates another vector 418 of length n² representing different transformed coefficients for a given signal block 410. FIG. 4 shows an example similar to LCEVC where the transform matrix 416 is a Hadamard matrix of size 4 by 4, resulting in a transformed coefficient vector 418 having four elements with respective values. These elements are sometimes referred to by the letters A, H, V and D as they may represent an average, horizontal difference, vertical difference and diagonal difference. Such a transform operation may also be referred to as a directional decomposition. When n=4, the transform operation may use a 16 by 16 matrix and be referred to as a directional decomposition squared.

As shown in FIG. 4, the set of values for each data element across the complete set of signal blocks 410 for the plane 408 may themselves be represented as a plane or surface of coefficient values 420. For example, values for the “H” data elements for the set of signal blocks may be combined into a single plane, where the original plane 408 is then represented as four separate coefficient planes 422. For example, the illustrated coefficient plane 422 contains all the “H” values. These values are stored with a predefined bit length, e.g. a bit length B, which may be 8, 16, 32 or 64 depending on the bit depth. A 16-bit example is considered below but this is not limiting. As such, the coefficient plane 422 may be represented as a sequence (e.g. in memory) of 16-bit or 2-byte values 424 representing the values of one data element from the transformed coefficients. These may be referred to as coefficient bits.

### Comparative Examples of Temporal Scalability

FIGS. 5 to 7 will now be described. These show three different comparative examples to aid explanation of the temporal scalability that is described later below with reference to FIGS. 8 to 15.

Some known (video) codecs have no temporal scalability. In such cases, if a video signal wants to be available at two different frame rates (e.g., 60 and 30 fps), then two separate streams have to be sent. For example, FIG. 5 shows an example 501 where a first stream 503 at 60 fps and a stream 505 at 30 fps are encoded separately and then transmitted. In this case, both streams 503, 505 comprise encoded data for the frames 507, 509 corresponding to the even timestamps below, but only the first stream 503 also comprises data 511 for frames corresponding to the odd timestamps. This arrangement is disadvantageous because there is duplication of work at the encoder (as it has to perform two sets of encoding) and also disadvantageous from a bandwidth perspective because two streams need to be sent. However, it is the easiest to implement, effectively comprising a simulcast system, and is often the most likely to be found in real world broadcast environments.

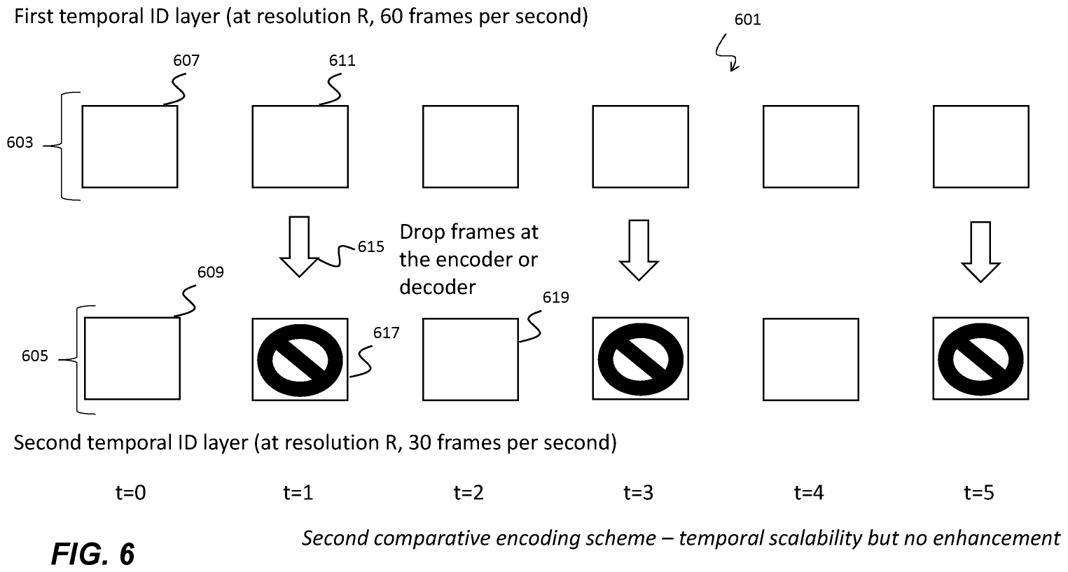

Some video codecs (e.g., those implemented according to the VVC or HEVC standards) allow for temporal scalability due to their frame structure. The frame structure allows for certain frames to be dropped (at the encoder or decoder) to arrive at a target frame rate. FIG. 6 shows a first video stream 603 that is encoded at 60 fps. In parallel, with the encoding of the first video stream 603, a second video stream 605 may be generated at 30 fps by dropping every other frame of the first video stream 603. For example, the encoded frame 607 at time t=0 for the first video stream 603 is retained to form the first frame 609 for the second video stream 605, but the encoded frame 611 at time t=1 for the first video stream 603 is dropped 615 (i.e., removed, discarded or deleted) such that the next encoded frame for the second video stream 605 is the t=2 frame 619 (which again is copied from the first video stream 603).

While the comparative coding scheme of FIG. 6 this provides temporal scalability, no other type of scalability can be provided by this scheme because the implementation merely amounts to dropping frames of a single stream. For example, it is not possible to increase the resolution or quality of such a stream. Moreover, despite these temporal scalability schemes appearing simple in theory, in practice it is often not possible to drop frames as indicated due to motion compensation and correlation between frames (e.g., so-called “inter” encoding).

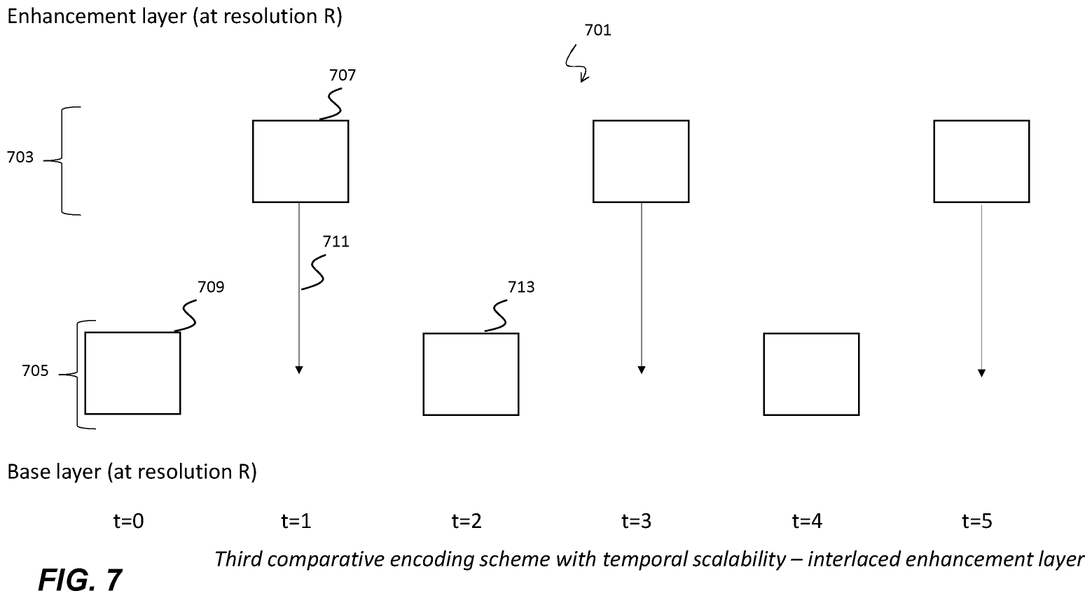

A third comparative scheme is shown in FIG. 7. In this comparative scheme, an enhancement layer 703 provides some form of temporal scalability by providing frames 707 that interlace with a base layer 705 to increase the frame rate. For example, additional encoded frames 707 may be generated and then inserted between successive frames 709, 713 of the base layer 703. In such systems, the resolution of the enhancement and base layer need to have the same resolution because they are being interlaced. Thus, and similarly to the system of FIG. 6, no other form of scalability can be provided using these methods. For example, the enhancement layer cannot improve the quality of the base layer frames because the frames of the enhancement layer merely interlace with the frames of the base layer.

Example Temporal Scalability Scheme Compatible with Spatial and/or Quality Scalability

An illustration of an example coding scheme that uses temporal scalability in a manner that is compatible with one or more of spatial and quality scalability is shown in FIG. 8. FIG. 8 shows a base stream 803 and an enhancement stream 805.

The base stream may be generated according to the comparative temporal scalability scheme described with reference to FIG. 6 (e.g., may comprise an HEVC or VVC base stream that is configured to implement temporal scalability by dropping frames). In FIG. 8, there are two versions of the base stream that are available at two different frames rates: a first stream 807 available at a first frame rate and a second stream 809 that is available at a second frame rate, where the first frame rate is higher than the second frame rate and the second frame rate is obtained by dropping (e.g., ignoring or deleting, or via selective memory access) a certain subset of encoded frames (in FIG. 8 every odd frame 817). It should be noted that the ratio between the first and second frame rate is shown as 2 for ease of example, but this may be any configurable value (e.g., an integer value such as 2, 3, or 4). The dropped frames 817 of the base stream 803 may be dropped at either the encoder or the decoder.

In FIG. 8, the enhancement stream 805 is generated using the base stream 803. The enhancement stream may be generated using the system and methods of FIGS. 1 to 4, e.g. may be an LCEVC enhancement bit stream. The enhancement stream 805 is also generated at two frame rates that correspond to the two frame rates of the base stream 803. In FIG. 8, the enhancement stream 805 comprises a first stream 811 that is generated at the first frame rate. The first stream 811 may, for example, be generated by generating an enhancement stream as shown in FIGS. 1 to 4 using the first base stream 807 as an input for the enhancement encoder (e.g., a decoded version of this base stream forms the output of the base decoder 120D. The first base stream 807 and the first enhancement stream 811 may optionally be at different spatial resolutions (e.g., as described with reference to FIGS. 1 to 4) and/or different levels of quality (e.g., different encoded bit rates). The enhancement stream 805 also comprises a second stream 813 that is at the second frame rate. The second stream 813 may be generated by dropping frames of the first stream 811, e.g. in a manner that corresponds to the ratio used by the two temporal layers 807, 811 of the base stream 803. The dropping of the frames may be performed at an encoder or at a decoder.

Hence, in the arrangement of FIG. 8 there is the option of two streams (base and enhancement 803, 805) with two respective levels of temporal scalability. The base and enhancement streams 803, 805 may thus be different levels of scalability in a non-temporal scheme (e.g., spatial and/or quality) such that the two respective levels of temporal scalability allow a combination of two or more of spatial, quality and temporal scalability.

Although, in comparative examples, it may be known to encode a base stream using a first encoding method (for example, VVC) and then to encode an enhancement stream using an LCEVC enhancement (e.g., as shown in FIGS. 1 to 4), it is not known to provide a temporally scalable enhancement stream, e.g. such as is shown in FIG. 8.

In FIG. 8, temporal scalability may be achieved by dropping frames (e.g., frames 417a-c) of the base stream 401. This dropping can be performed at the encoder side or the decoder side. Corresponding frames of the enhancement stream may then also be dropped (e.g., frames 819a to 819c).

In certain examples, to allow a dropping of frames in the enhancement stream, a temporal mode of LCEVC that uses a temporal buffer for computing residual differences between frames may be deactivated. This may be performed by specifying the temporal mode (e.g., as “off”) in the configuration of the enhancement encoder.

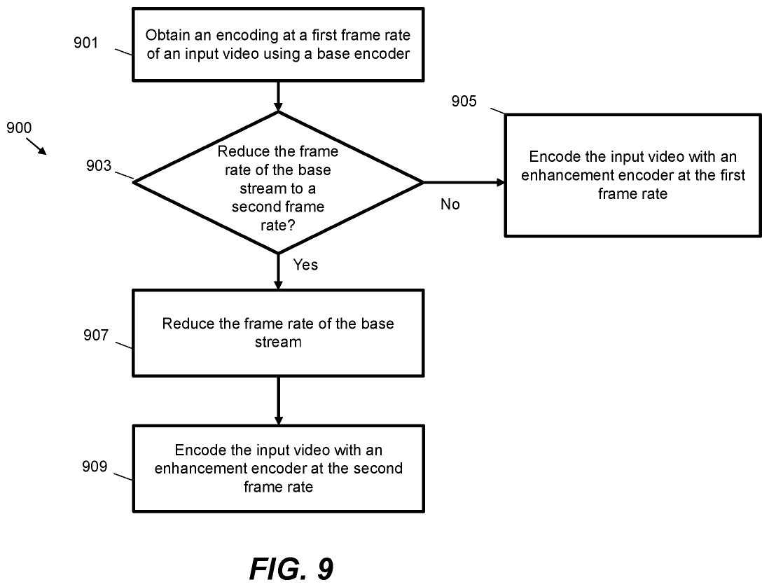

FIGS. 9 to 11 show a number of alternative methods for implementing a temporally scalable coding scheme (e.g., such as that shown in FIG. 8).

FIG. 9 shows a method 900 for modifying a frame rate of combined base and enhancement streams. At step 901, a base encoding of an input video signal is obtained. The base encoding is encoded using a base encoder to encode the input video signal at a first frame rate. For example, the base encoding may comprise the first temporal layer 807 of the base stream 803 in FIG. 8. The first frame rate may be a higher frame rate (e.g., 60 or 120 fps). At step 903, a decision is made as to whether to modify the frame rate. For example, as part of the transmission of the combined base and enhancement streams a decision may be made to lower the frame rate due to network congestion. Responsive to a decision to maintain the first frame rate, at step 905 an enhancement stream is generated using the base encoding at the first frame rate. For example, this may comprise applying the systems and methods of FIGS. 1 to 4 to frames of an input video at the first frame rate. The output of step 905 may comprise an enhancement stream similar to stream 811 in FIG. 8. Responsive to a decision to modify the first frame rate, such as to reduce the first frame rate to a second frame rate, then at step 907, the frame rate of the base encoding is modified. This may comprise selecting a subset of frames of the base encoding to obtain the base encoding at the second frame rate. For example, frames of the base encoding may be dropped to generate the second temporal layer 809 of the base stream 803 as shown in FIG. 8. At block 909, the base encoding at the second frame rate is used to generate an enhancement encoding. Like step 905, this may comprise applying the systems and methods of FIGS. 1 to 4, but in step 909 this is applied to frames of an input video at the second frame rate and using the second temporal layer 809 of the base stream 803 as shown in FIG. 8.

In the example of FIG. 9, there is no restriction to the frame structure of the enhancement stream, because a decoder does not drop frames from the enhancement stream to generate the lower frame rate (because the enhancement stream has been encoded at the lower frame rate). Therefore, in examples where the enhancement stream is an LCEVC enhancement stream, temporal prediction can be enabled for both steps 905 and 909. In this example, the decoder receives either a combined base and enhancement stream at the first frame rate as output from step 905 or a combined base and enhancement stream at the second frame rate as output from step 909 would decode the base stream and enhancement stream at the low frame rate. The input video, such as 10 in FIG. 1, may be modified in step 909 such that only every X frames are supplied as input, where X represent the temporal scalability ratio discussed above.

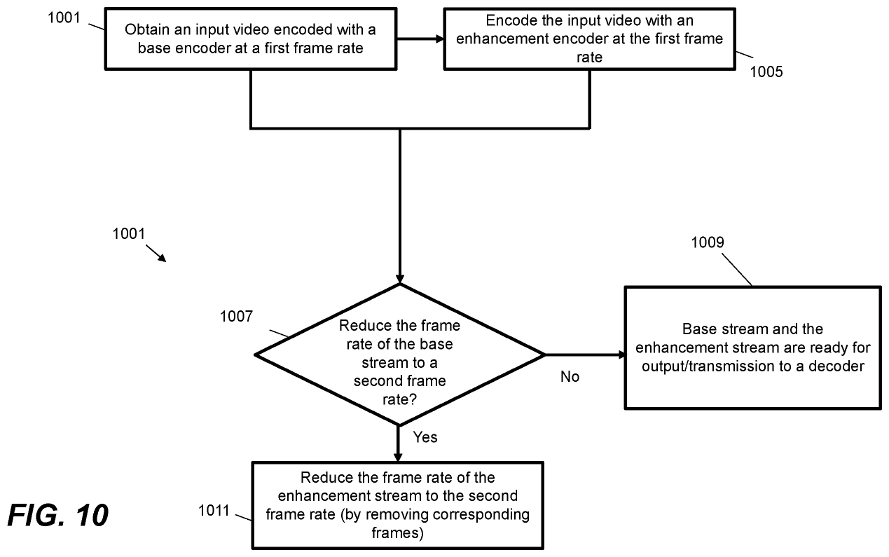

FIG. 10 is a flow chart illustrating an alternative method of providing temporal scalability with base and enhancement streams. At step 1001, a base encoding at a first frame rate is obtained. This may comprise encoding an input video with a base encoder such as 120E at the first frame rate, which may be a higher frame rate. At step 1005, the base encoding is decoded and used to encode the input video with the enhancement encoder (e.g., an LCEVC encoder) at the first frame rate. This may comprise applying the systems and methods of FIGS. 1 to 4 with a set of received input video frames and base encoded frames at the first frame. In this example, as enhancement frames may be dropped, the enhancement encoder is preferably configured with a temporal mode deactivated (i.e., such that there is no dependency between frames). The encoding using the enhancement encoder may be done alongside the encoding with the base encoder, e.g. it may also be done sequentially frame-by-frame such that once a base encoded frame is available, it may be decoded and used to generate the enhancement encoding. Alternatively, the base encoding may be applied to generate a file representing a base encoding at the first frame rate, where the file may be subsequently processed by an enhancement encoder (e.g., by calling on a base decoder) to produce the enhancement encoding.

At step 1007, a base encoding and an enhancement encoding at the first frame rate are available (e.g., as represented by streams 807 and 811 in FIG. 8). At step 1007, in a similar manner to step 907, a decision is made as to whether to reduce the frame rate of the base stream to a lower frame rate (e.g., 30 fps) or to keep the first frame rate. If the frame rate of the base stream is not reduced, then the base stream and the enhancement stream are ready for output or transmission to a decoder. If the frame rate of the base stream is to be reduced, then the frame rate of the enhancement stream is reduced to a second frame rate at step 1011. This may be performed as shown in FIG. 8, e.g. by dropping every X encoded frames that are output from step 1005 to generate stream 813. If the frame rate of the enhancement stream is reduced, then at step 1011 the frame rate of the base stream may also be reduced to the second frame rate, e.g. via dropping frames as shown in FIG. 8 to generate the base stream 809.

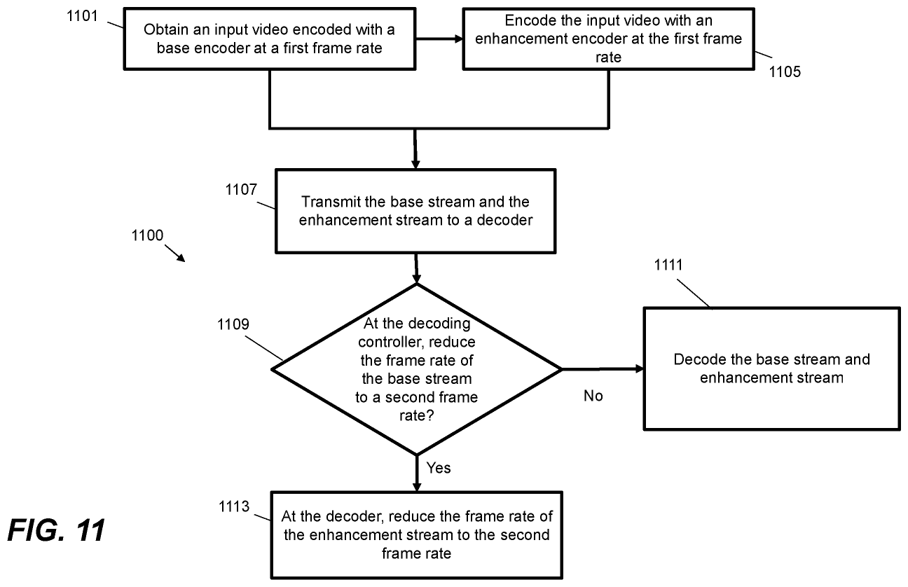

The methods of FIGS. 9 and 10 may be performed at an encoding device. FIG. 11 is a flow chart illustrating a method that may be performed, in part, at a decoding device. In this example, steps 1101 and 1105 are performed as per steps 1001 and 1005 of FIG. 10. At step 1107, the base stream and enhancement stream, which are encoded at the first frame rate, are transmitted to the decoding device. At step 1109, at a controller of the decoding device, a decision is made as to whether reduce the frame rate from the first frame rate to a second frame rate. For example, the controller may determine whether there is an available decoder as part of a codec that is able to decode one or more of the base stream and the enhancement stream at the first frame rate. If, at step 1109, the frame rate is not to be modified, then the decoding device decodes the base and enhancement stream at the first frame rate, e.g. applying the decoder 200 of FIG. 2 at the first frame rate. If, at step 1109, the frame rate is to be modified, e.g. because one or more of a base decoder and an enhancement decoder is not able to decode at the first frame rate, then at step 1113 the controller reduces the frame rate of the base and enhancement streams to the second frame rate. For example, the controller at the decoding device may drop frames in both the base and enhancement streams to generate streams 809 and 813. The controller may then pass the base and enhancement streams at the second frame rate to a decoder such as decoder 200 of FIG. 2. The controller can reduce the frame rate one a frame-by-frame basis or may reduce the frame rate at a file level (e.g., if the decoding device is accessing a file). In certain cases, the encoding device may signal to the decoding device control data that indicates whether step 1111 or step 1113 is to be performed. In one case, this control data may be sent from a device independent of the encoding device, e.g. a network device that measures congestion. In one case, the controller may apply step 1109 based on local conditions evaluated at the decoding device, e.g. a level of available resources.

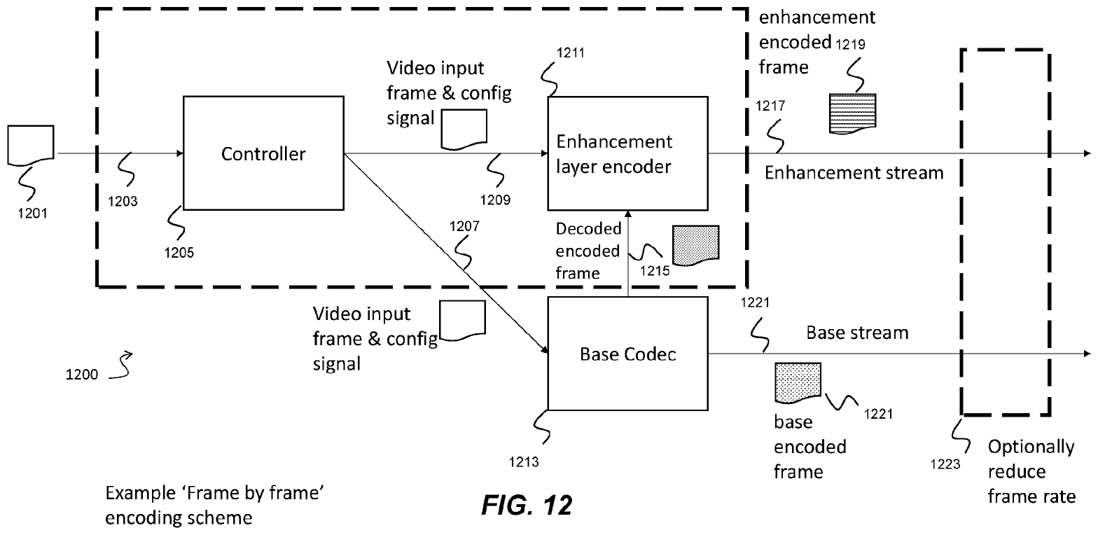

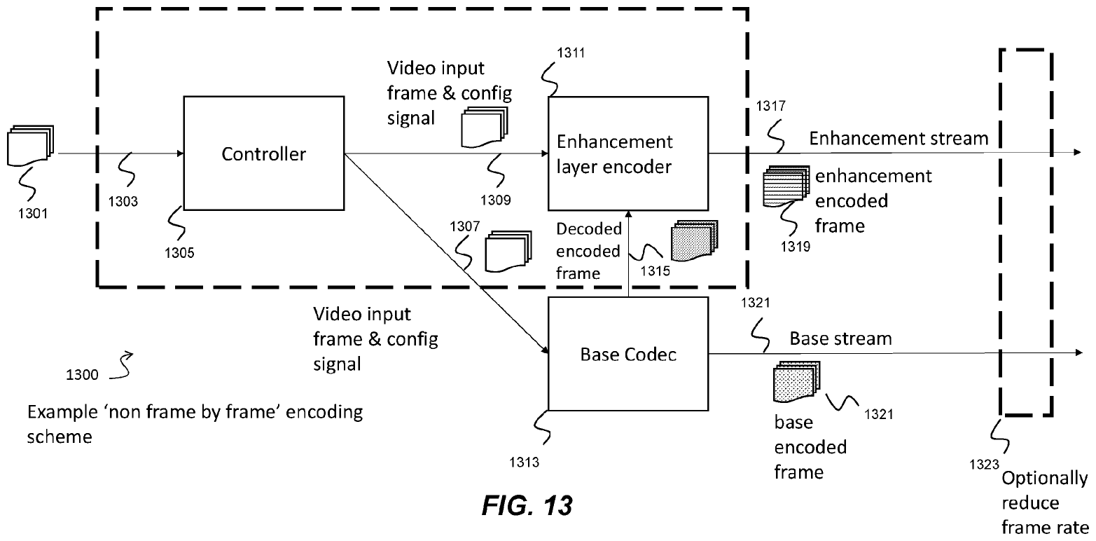

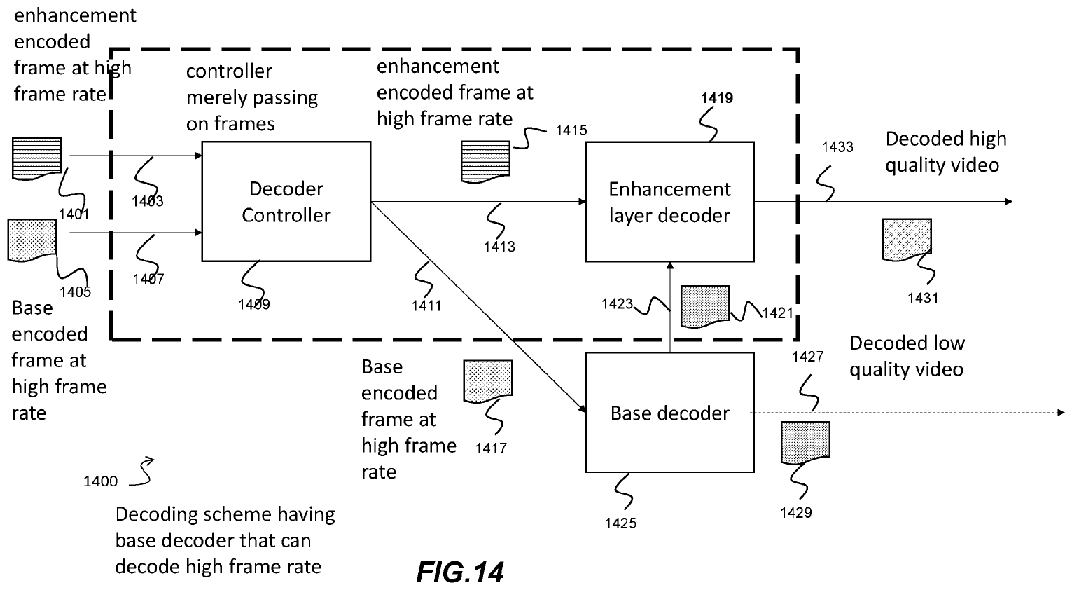

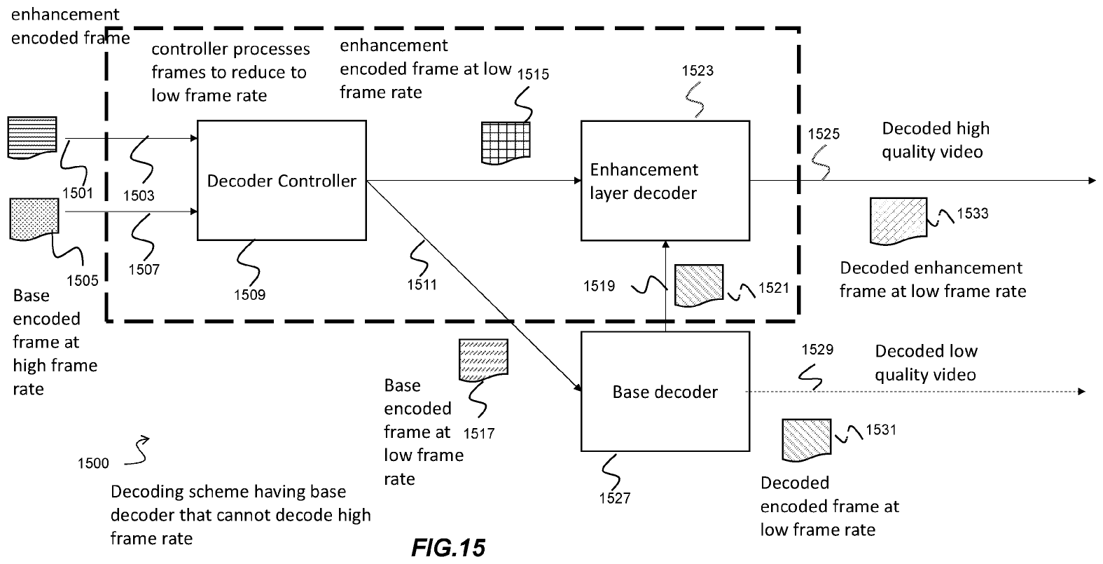

FIGS. 12 and 13 show an example encoder that may be configured to perform any of the methods of FIGS. 9 to 11. FIGS. 14 to 15 show at example decoder. FIG. 14 shows an example decoder implementing step 1111 of FIG. 11 and FIG. 15 shows an example decoder implementing step 1113 of FIG. 11.

FIG. 12 shows an example encoder 1200 comprising a controller 1205 to receive (1203) an input video 1201 at a first frame rate. The controller is communicatively coupled to a base encoder 1213 and an enhancement encoder 1211. The controller 1205 is configured to make the input video and a base encoding configuration 1207 available to the base encoder and to make the input video and an enhancement encoding configuration 1209 available to the enhancement encoder 1211. The enhancement encoder 1211 receives a decoding 1215 of an output of the base encoder as applied to the input video to perform an enhancement encoding of the input video. In FIG. 12, the base encoder 1213 forms part of a base codec that includes base encoder and base decoder components (although these may be provided separately). The base encoder 1213 generate an encoded base stream 1221 and the enhancement encoder generating an encoded enhancement stream 1217. The base encoding configuration may instruct the base encoder 1213 to generate the encoded base stream with a plurality of temporal layers, wherein a first of the temporal layers may be decoded independently of a second of the temporal layers. The enhancement encoding configuration 1209 may disable a temporal buffer in the enhancement encoder such that each frame of the encoded enhancement stream is encoded independently. This arrangement thus enables an encoding device to switch between two frame rates by dropping frames of one or more of the encoded base stream and the encoded enhancement stream (e.g., as shown by box 1223). FIG. 13 shows the same configuration (with similar reference numerals) but for a case where encoding is performed for a whole file at a time, rather than frame by frame as per the example of FIG. 12.

FIG. 14 shows an example decoder 1400 comprising a controller 1409 to receive 1403, 1407 an encoded base stream 1405 and an encoded enhancement stream 1401. The encoded enhancement stream 1401 is generated using the encoded base stream 1405. The encoded base stream 1405 comprising a plurality of temporal layers, wherein a first of the temporal layers may be decoded independently of a second of the temporal layers. The frames of the encoded enhancement stream 1401 are encoded independently of each other. FIGS. 14 and 15 show the same decoder in different configurations. The controller 1409, 1509 is further configured to switch between two frame rates by dropping frames of one or more of the encoded base stream and the encoded enhancement stream, prior to respective decoding with a base decoder and an enhancement decoder.

In these examples, the encoded enhancement stream provides for one or more of an increase of spatial resolution or a decrease of an error when compared to an original signal.

FIG. 16 shows an example base stream that may be configured as per the base stream shown in FIG. 8. In this example, there are multiple temporal layers. In this case, frames may be dropped by removing the frames of any one temporal layer.

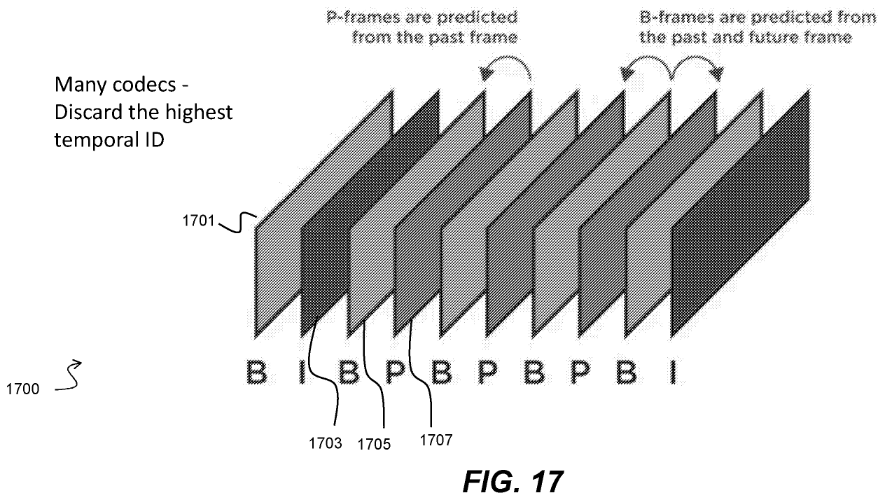

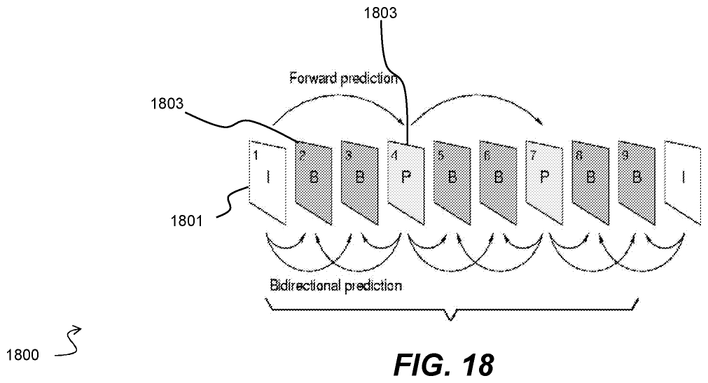

FIGS. 17 and 18 show configurations for temporal prediction within a base stream that may be configured such that base frames may be dropped to provide temporal scalability within the base stream.

The frame structure of the base stream is configured in the present examples such that it is capable of having frames dropped. The frame structure of the enhancement stream only needs to be considered for the examples of FIGS. 10 and 11.

Certain examples described herein enable three different forms of scalability that may be used in combination:
Spatial scalability, e.g. the supply of different enhancement streams to enable an increase in spatial resolution, such as allowing a video to be rendered in High Definition (HD) for a base stream and Ultra High Definition (UHD) for an enhanced stream. Spatial scalability may also enable different viewing modes, e.g. such as changing from portrait to landscape, or 16:9 to widescreen. In general, spatial scalability changes the number of pixels and may be implemented using the systems and methods of FIGS. 1 to 4 (e.g., via upsampling and the addition of the sub-layer 2 residuals).
Quality scalability, e.g. for a fixed spatial and/or temporal resolution, varying a match with an original input video. For example, the sub-layer 1 stream as described with reference to FIGS. 1 to 4 provides quality scalability, a decoded video from the base stream at a defined resolution (e.g., HD) is “corrected” by the sub-layer 1 residuals while remaining at the defined resolution (e.g., the sub-layer 1 residual plane is also HD). In this case, a frame with the same number of pixels appears ‘sharper’, as the final image is closer to the original. Although the examples of FIGS. 1 to 4 provide both spatial and quality scalability, it should be noted that these may be provided independently (e.g., spatial scalability may be disabled by turning off the upsampling 105U, 205U while retaining one or more of the sub-layer residuals).
Temporal scalability, e.g. switching frame rate. This may be implemented using the methods of FIGS. 8 to 15 and may be implemented in combination with the spatial and/quality scalability provided by the arrangement of FIGS. 1 to 4. Temporal scalability may allow switching on the fly from 60 fps to 30 fps, e.g. for a given period of time, e.g. 2 seconds. The switching and the time period of the change may be controlled based on streaming and/or rendering conditions.

Certain examples described herein may thus encode one or more of the following properties at multiple levels: frame rate of input video signal, resolution of input video signal, and visual quality of input video signal.

Within base streams, such as AVC and VVC, a ‘random access’ structure such as that shown in FIG. 16 may enable the encoded base stream to be modified to drop a subset of frames. A particular temporal layer may be identified using a temporal layer identifier (ID) and discarded. For example, a ‘top’ temporal layer of a base encoded video stream may be identified and discarded using the temporal layer identifier. For the example of FIG. 16, this may comprise discarding every second frame of the base stream as shown in FIG. 8.

Another approach for modifying the base stream may be applied to the base configuration of FIG. 17. This may be referred to as an “IBP approach”. If the encoded base stream is configured such that B (bi-directionally encoded) frames of the base are sandwiched between non-B frames, then the B frames may be discarded to generate the modified base stream 809 because no other frames that are inferred (or predicted) from the B frames. In certain examples, the methods of FIGS. 9 to 11 may comprise configuring an encoder such that the base stream is encoded with a compatible IBP frame order/structure. For example, an LCEVC encoder may instruct a base encoder to encode the base stream 807 with this structure.

The IBP approach described with respect to FIG. 17 may be extended for different numbers of intermediate B frames to allow different temporal ratios between the two versions of the base stream (e.g., 807 and 809). FIG. 18 shows a case where there are two intermediate B frames (e.g., between I and P frames). This “×BB×” encoding configuration may be instructed as part of the base encoding and then enables a temporal ratio of 1:3 (i.e., dropping 2 out of every 3 frames), wherein the B frames may be again discarded, leaving the non-B frames. In certain cases, the B frames may be seen as a “higher” temporal layer (e.g., temporal layer ID 0) and the I and P frames may be seen as a “lower” temporal layer (e.g., temporal layer ID 1).

In certain cases, the base encoding may be configured via command line or program calls to a base encoder and/or a particular memory access procedure. For example, if the base encoder is configured to store a base stream with data that is identified with a particular temporal layer identifier, the temporal layer identifier may be used to access subsets of the base encoded frames to obtain the modified base stream (e.g., 809). These examples involve the configuration of a base encoder to have a specific frame structure to allow for dropping of frames with a highest temporal ID (e.g., highest in a temporal hierarchy). Once the base encoding is generated using this configuration, the frames with the highest temporal ID can be dropped, e.g. either before sending them at the encoder or after receiving them at the decoder

It shown be noted that the base stream configurations shown in FIGS. 16 to 18 do not apply to an enhancement stream as generated using the encoder system and methods of FIGS. 1 to 4. The corresponding configuration that may be made to this enhancement encoder system is to disable a temporal buffer for the sub-layer 2 residuals (e.g., set a flag to deactivate the “temporal mode” in LCEVC).

A specific example using VVC as the base encoding method and LCEVC as the enhancement coding method will now be briefly described.

In this case, temporal scalability with LCEVC can be accomplished by utilizing different frame structures of the underlying base codec, VVC in this example. In the default VVC random access (RA) configuration, every second frame is encoded at the highest temporal ID and therefore other frames are not inferred from these frames. This characteristic allows to discard the frames at the highest temporal ID without breaking the decoding process. LCEVC enhancement data can then be added on top of the base frames (e.g., as described above). An encoder may choose to discard frames with the highest temporal ID in the base layer and corresponding frames in its LCEVC enhancement data in the bitstream without impacting the decoding process of the modified bitstream. The same concept can be achieved by using different frame hierarchy structures within the base encoder, depending on capabilities of the base codec.

Turning to the example, first a base layer or stream is encoded using a VVC encoder, e.g. using command line commands. The VVC encoder is instructed to use one of the configurations shown in FIGS. 16 to 18. Then the base layer or stream is decoded by a WC decoder to generate a base (decoded) YUV file. This may be an implementation of any of steps 901, 1001, 1101. The base (decoded) YUV file is then used to create an LCEVC bitstream (e.g., as described with reference to steps 1005 or 1105). The temporal mode is deactivated for LCEVC by setting an encoding configuration flag. As described in FIGS. 10 and 11, the frames of both the VVC base stream and the LCEVC enhancement stream may then be dropped if instructed (e.g., as shown as step 1011 or 11130. For example, in a test case, a base stream as generated above was configured to switch between the framerates 59.94 Hz and 39.97 Hz every 128 frames (2 seconds). The first 128 frames were encoded at 59.94 Hz, while frames 128-255 were configured to use the lower framerate at 39.97 Hz and duplicate each frame in the output file. The LCEVC bitstream was then encoded at a rate of 6.42 Mb/s.

Certain examples herein may involve setting, instructing, or obtaining a configuration of (e.g., a temporal hierarchy/structure of) a (base) encoder such that the decoding of the base encoded layer is decodable at a maximum frame rate and at a reduced frame rate. This may involve instructing the base encoder to encode the video signal in accordance with the determined configuration. It may also involve signalling to an enhancement layer encoder to encode a video signal such that the decoding of each enhancement layer encoded frame is independent of a decoding of any other enhancement layer encoded frame. Certain examples may involve a method of encoding an input video signal as a temporally scalable bitstream, wherein the input video signal comprises multiple frames, wherein the temporally scalable bitstream is decodable to produce a decoded video signal at a higher frame rate, wherein the temporally scalable bitstream is decodable to produce a decoded video signal at a lower frame rate, and wherein the lower frame rate is a target percentage of the higher frame rate. This method may comprise instructing an enhancement (e.g., LCEVC) encoder to generate an encoded enhancement layer by encoding the input video signal, wherein the instructing signals a disabling of a temporal buffer (of the enhancement encoder, e.g. used in sub-layer 2) such that frames of the encoded enhancement layer are decodable independently of other frames of the encoded enhancement layer.

Example applications of the described temporal scalability mechanisms are streaming or video conferencing systems. Temporal scalability refers to the ability to reduce the frame rate of an encoded bitstream by dropping packets, thereby, reducing the bit rate of the stream.

Advantageously, the described examples provide for temporal scalability. This is useful for video services which require different temporal resolutions or frame rates. For example, transmitting video over a wireless channel where a video frame rate may need to be dropped when the channel condition is poor. Described examples may also be used for stereoscopic video and coding of future HDTV formats in which the baseline is to make the migration from the lower temporal resolution systems to the higher temporal resolution systems possible. The presently described examples differ from cases where a base layer is encoded at a lower frame rate and then an enhancement layer is used to increase the frame rate, e.g. by adding additional frames as shown in FIG. 7.

The techniques described herein may be implemented in software or hardware, or may be implemented using a combination of software and hardware. They may include configuring an apparatus to carry out and/or support any or all of techniques described herein.

The above examples are to be understood as illustrative. Further examples are envisaged.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A method of encoding a video signal comprising:
obtaining a base encoding of an input video signal, the base encoding being encoded using a base encoder to encode the input video signal at a first frame rate; and
encoding the input video signal using an enhancement encoder to generate an enhancement encoding of the input video signal at a second frame rate, the enhancement encoder encoding the input video signal using at least a set of frames derived from the base encoding.

2. The method of claim 1, comprising:
obtaining the base encoding at the first frame rate;
encoding the input video signal at the first frame rate using the enhancement encoder to generate the enhancement encoding, the enhancement encoder using base encoding at the first frame rate; and
selecting a subset of frames of the enhancement encoding to obtain the enhancement encoding at the second frame rate,
the second frame rate being lower than the first frame rate.

3. The method of claim 2, comprising:
selecting a subset of frames of the base encoding to obtain the base encoding at the second frame rate.

4. The method of claim 1, comprising:
obtaining the base encoding at the first frame rate;
selecting a subset of frames of the base encoding to obtain the base encoding at the second frame rate; and
encoding the input video signal using the enhancement encoder to generate the enhancement encoding of the input video signal at the second frame rate, the enhancement encoder using the base encoding at the second frame rate,
the second frame rate being lower than the first frame rate.

5. The method of any one of claims 1 to 4, wherein the base encoding is at a first resolution and the enhancement encoding is at a second resolution, the second resolution being higher than the first resolution.

6. The method of claim 5, wherein the enhancement encoding comprises two sub-layers, a first sub-layer comprising residuals at the first resolution and a second sub-layer comprising residuals at the second resolution.

7. The method of any one of claims 1 to 6, wherein the base encoding is at a first level of quality and the enhancement encoding is at a second level of quality, the second level of quality being higher than the first level of quality.

8. The method of any one of claims 1 to 7, comprising:
outputting an enhancement encoding at both the first frame rate and the second frame rate for pairing with respective base encodings at the first frame rate and the second frame rate.

9. The method of any one of claims 1 to 8, comprises:
transmitting the enhancement encoding at the second frame rate to a decoder.

10. The method of claim 9, comprising:
arranging for the transmission of the base encoding at the second frame rate to the decoder.

11. The method of any one of the preceding claims, comprising:
configuring the base encoder such that a ratio between the first frame rate and second frame rate is a power of 2.

12. The method of claim 11, comprising:
configuring the base encoder to generate encoded frames having hierarchical B frames.

13. The method of claim 11, comprising:
configuring the base encoder to generate one or more groups of pictures, each group of pictures comprising: an intra coded frame, followed by one or more sets of a single B frame, followed by a single P frame.

14. The method of any one of claims 1 to 11, comprising:
configuring the base encoder such that a ratio between the first frame rate and second frame rate is a power of 3; and
configuring the base encoder to generate one or more groups of pictures, each group of pictures comprising: an intra coded frame, followed by two or more sets of a single B frame, followed by a single P frame.

15. The method of any one of the preceding claims, comprising:
disabling a temporal buffer available to the enhancement encoder.

16. A method of decoding a video signal, comprising:
receiving a base encoding at a first frame rate and an enhancement encoding at a second frame rate;
modifying data for at least the enhancement encoding to obtain an enhancement encoding at a third frame rate, the third frame rate being less than at least one of the first and second frame rates; and
decoding the enhancement encoding at the third frame rate using data from a decoding of the base encoding.

17. The method of claim 16, wherein the first frame rate and the second frame rate are the same frame rate and modifying at least the enhancement encoding comprising discarding encoded frames of the enhancement encoding.

18. The method of any of the preceding claims wherein the base encoder is any one of a VVC, HEVC, SHVC, SVVC encoder.

19. The method of any one of the preceding claims, wherein the enhancement encoder generates a MPEG-5 Part 2 LCEVC (“Low Complexity Enhancement Video Coding”) compatible enhancement encoding.

20. A method of encoding a video signal comprising:
obtaining an encoding of an input video signal, the encoding being generated using a base encoder as a base stream at a first frame rate, the base stream at the first frame rate comprising a first set of encoded consecutive frames at the first frame rate,
wherein the first set of encoded frames comprises one or more droppable frames, where said droppable frames are frames that can be removed from the first set of encoded frames without preventing decoding of any unremoved frames of the first set of encoded frames,
the method further comprising either:
removing, from the first set of encoded frames, said one or more droppable frames to generate a base stream having a second frame rate, the second frame rate being lower than the first frame rate; and
encoding the input video signal using an enhancement encoder to generate an enhancement stream for the base stream, the enhancement stream comprising a second set of encoded consecutive frames at the second frame rate; or
encoding the input video signal using the enhancement encoder to generate the enhancement stream for the base stream, the enhancement stream comprising a second set of encoded frames comprising consecutive encoded frames at the first frame rate; and
removing, from the second set of encoded frames at the first frame rate, frames corresponding to said one or more droppable frames of the first set of encoded frames.

21. An encoder comprising:
a controller to receive an input video at a first frame rate, the controller being communicatively coupled to a base encoder and an enhancement encoder, the controller making the input video and a base encoding configuration available to the base encoder and making the input video and an enhancement encoding configuration available to the enhancement encoder, wherein the enhancement encoder receives a decoding of an output of the base encoder as applied to the input video to perform an enhancement encoding of the input video, the base encoder generating an encoded base stream and the enhancement encoder generating an encoded enhancement stream.

22. The encoder of claim 21, wherein the base encoding configuration instructs the base encoder to generate the encoded base stream with a plurality of temporal layers, wherein a first of the temporal layers may be decoded independently of a second of the temporal layers.

23. The encoder of claim 21 or claim 22, wherein the enhancement encoding configuration disables a temporal buffer in the enhancement encoder such that each frame of the encoded enhancement stream is encoded independently.

24. The encoder of any one of claims 21 to 23, wherein the controller is configured to switch between two frame rates by dropping frames of one or more of the encoded base stream and the encoded enhancement stream.

25. A decoder comprising:
a controller to receive encoded base stream and an encoded enhancement stream, the encoded enhancement stream being generated using the encoded base stream, the encoded base stream comprising a plurality of temporal layers, wherein a first of the temporal layers may be decoded independently of a second of the temporal layers, the frames of the encoded enhancement stream being encoded independently of each other, the controller being further configured to switch between two frame rates by dropping frames of one or more of the encoded base stream and the encoded enhancement stream, prior to respective decoding with a base decoder and an enhancement decoder.

26. The encoder or decoder of any one of claims 21 to 25, wherein the encoded enhancement stream provides for one or more of an increase of spatial resolution or a decrease of an error when compared to an original signal.
